(19) United States
(12) Patent Application Publication
(10) Pub. No.: US 2006/0004663 A1
(43) Pub. Date: Jan. 5, 2006

(54) Method and apparatus for a private information system and service transactions that minimize theft of identity data

(76) Inventor: Tara Chand Singhal, Torrance, CA (US)

Correspondence Address: Tara Chand Singhal, P O Box 5075, Torrance, CA, 90510, US

(21) Appl. No.: 11/152,322

(22) Filed: Jun. 10, 2005

Related U.S. Application Data
(62) Division of application No. 09/570,232, filed on May 12, 2000, now Pat. No. 6,938,022.

(51) Int. Cl. G06F 17/60

(52) U.S. Cl. 705/51

(57) ABSTRACT

A method and apparatus (10) for a privacy system (12) that facilitates anonymous service transactions globally between a customer (20) and a service merchant (22) and that minimizes the theft of personally sensitive identity data. The privacy system (12) allows the customer (20) to receive service (60) from the merchant (22) over the Internet without the merchant (22) receiving and keeping the identity data, bankcard information and other personally sensitive Id theft prone data of the customer (20). Invention also discloses a private information system on Internet using an anonymous identifier to store private information that minimizes the theft of personally sensitive identity data. The anonymous identifier is self-created by a person to assure anonymity to the person to facilitate anonymous and secure transactions over the Internet.

### CROSS REFERENCE TO RELATED APPLICATIONS

This application is divisional application of application Ser. No. 09/570,232, filed May 12, 2000, titled, “Method and Apparatus for Facilitating an Anonymous Private Information System and Anonymous Service Transactions”. Examiner John W Hays, Art Unit 3621, in which a notice of allowance dated Mar. 22, 2005 had been issued. The contents of application Ser. No. 09/570,232 are incorporated herein by reference.

84. A method of protecting Identity theft sensitive personal data of a customer from a service provider over a global computer network, comprising the steps of:
a. receiving customer data by a primary service provider;
b. partitioning the customer data into customer identifying data and customer non-identifying data, the non-identifying data being the data necessary to provide a service by a secondary service provider;
c. assigning a non-customer identifying reference to the customer non-identifying data and forwarding the reference and the customer non-identifying data to the secondary service provider.

85. The method of claim 84 further comprising the steps of:
facilitating receiving customer data by providing forms that support different types of customer service from a group of, (i) data that supports a loan application, (ii) data that supports a tax computation, (iii) data that supports financial planning, (iv) data that supports custom fitting of wearable articles, (v) data that supports an application for insurance quotes, and (vi) data that supports health care advice.

86. The method of claim 84 further comprising the steps of:
selecting by the customer the secondary service provider from a list of service providers.

87. The method of claim 84 further comprising the steps of:
a. processing a payment, using existing payment authorization networks by the primary service provider, from the customer to the secondary service provider for payment of the service;
b. forwarding payment authorization data to the secondary service provider with the non-customer identifying reference.

88. The method of claim 84 further comprising the steps of:
a. receiving the results of the service from the secondary service provider;
b. associating the results with the customer identifying data.

89. The method of claim 88 further comprising the steps of:
forwarding the results of the service to the customer.

90. The method of claim 89 further comprising the steps of:
processing further the received results from the secondary service provider before forwarding to the customer.

91. The method of claim 88 further comprising the steps of:
forwarding the results of the service to a plurality of third parties selected by the customer.

92. A system for protecting identity theft sensitive personal data of a customer from a service provider over a global computer network, comprising:
a. a function that enables receiving customer data by a primary service provider;
b. a function that partitions the customer data, by the primary service provider, into customer identifying data and customer non-identifying data, the non-identifying data being the data necessary to provide a service by a secondary service provider;
c. a function that assigns a non-customer identifying reference to the customer non-identifying data and forwards the reference and the customer non-identifying data to the secondary service provider.

93. The system as in claim 92 further comprising:
a function that facilitates receiving customer data by providing forms that support different types of customer service from a group of, (i) data that supports a loan application, (ii) data that supports a tax computation, (iii) data that supports financial planning, (iv) data that supports custom fitting of wearable articles, (v) data that supports an application for insurance quotes, and (vi) data that supports health care advice.

94. The system as in claim 92 further comprising:
a function that enables the customer to select the secondary service provider from a list of service providers.

95. The system as in 92 further comprising:
a function that processes a payment, from the customer to the secondary service provider for payment of the service, using existing payment authorization networks and forwards payment authorization data to the secondary service provider.

96. The system as in claim 92 further comprising:
a. a function that receives the results of service from the secondary service provider;
b. a function that associates the results with the customer identifying data and forwards the results to the customer.

97. The system as in claim 96 further comprising:
a function that forwards the results of the service to a plurality of third parties selected by the customer.

98. A system of identifying and verifying a customer to an information system comprising:
a. an access function that presents a screen, that requires entry of an initial sequence of data items from the customer;
b. the initial sequence of data have a format of data items from a group that includes at least three items from a group of, (i) zip code, (ii) name initials, (iii) a date, (iv) personal like and dislike phrase, (v) a personal number, (iv) gender, wherein the format of data is intended to facilitate customer in being able to create a unique sequence by memory association with these known formats.
c. a function that receives the sequence and creates a new customer record in the information system, for anchoring customer information.

99. The system as in claim 98, comprising:
a. a function that maps the sequence to a unique reference number that is then used for anchoring customer information;
b. the unique reference number is used to anchor customer information from a group of, (i) data that supports a loan application, (ii) data that supports a tax computation, (iii) data that supports financial planning, (iv) data that supports custom fitting of wearable articles, (v) data that supports an application for insurance quotes, (vi) data that supports health care advice, and (vii) data that is used for contacting the customer.

100. The system as in claim 98, comprising:
a. a function that uses the subsequent entry of the sequence for mapping to the unique reference number for then mapping to customer data of the customer;
b. a plurality of functions that support data processing activity such as changing, adding, deleting and retrieval of customer data.
